(19) United States
(12) Patent Application Publication
(10) Pub. No.: US 2026/0046416 A1
(43) Pub. Date: Feb. 12, 2026

(54) METHOD, APPARATUS, AND MEDIUM FOR VIDEO PROCESSING

(71) Applicants: Douyin Vision Co., Ltd., Beijing (CN); Bytedance Inc., Los Angeles, CA (US)

(72) Inventors: Wenjie ZHANG, Beijing (CN); Yuwen He, Los Angeles, CA (US); Li Zhang, Los Angeles, CA (US)

(21) Appl. No.: 19/362,063

(22) Filed: Oct. 17, 2025

Related U.S. Application Data
(63) Continuation of application No. PCT/CN2024/088391, filed on Apr. 17, 2024.

(30) Foreign Application Priority Data
Apr. 18, 2018 (WO) PCT/CN2023/088843

(51) Int. Cl. H04N 19/146; H04N 19/172; H04N 19/176; H04N 19/436

(52) U.S. Cl. CPC H04N 19/146; H04N 19/172; H04N 19/176; H04N 19/436

(57) ABSTRACT

Embodiments of the present disclosure provide a solution for video processing. A method for video processing is proposed. The method comprises: determining, for a conversion between a current frame of a video and a bitstream of the video, rate control information for encoding a current block in the current frame, the rate control information being determined at least based on information of a first set of blocks in the current frame that is encoded before the current block; and performing the conversion based on the rate control information.

### CROSS REFERENCE TO RELATED APPLICATIONS

This application is a continuation of International Application No. PCT/CN2024/088391, filed on Apr. 17, 2024, which claims the benefit of International Application No. PCT/CN2023/088843, filed on Apr. 18, 2023. The entire contents of these applications are hereby incorporated by reference in their entireties.

### FIELDS

Embodiments of the present disclosure relates generally to video processing techniques, and more particularly, to rate control design.

### BACKGROUND

In nowadays, digital video capabilities are being applied in various aspects of peoples' lives. Multiple types of video compression technologies, such as MPEG-2, MPEG-4, ITU-TH.263, ITU-TH.264/MPEG-4 Part 10 Advanced Video Coding (AVC), ITU-TH.265 high efficiency video coding (HEVC) standard, versatile video coding (VVC) standard, have been proposed for video encoding/decoding. However, coding quality of video coding techniques is generally expected to be further improved.

### SUMMARY

Embodiments of the present disclosure provide a solution for video processing.

In a first aspect, a method for video processing is proposed. The method comprises: determining, for a conversion between a current frame of a video and a bitstream of the video, rate control information for encoding a current block in the current frame, the rate control information being determined at least based on information of a first set of blocks in the current frame that is encoded before the current block; and performing the conversion based on the rate control information.

Based on the method in accordance with the first aspect of the present disclosure, rate control information is determined for a block in a frame based on information of previously coded block(s). In other words, the rate control is performed at a block level. Compared with the conventional solution where the rate control is performed at a frame level, the proposed method can advantageously perform the rate control at a smaller granularity, and thus the bitrate can be controlled more accurately. Thereby, the coding quality can be improved.

In a second aspect, another method for video processing is proposed. The method comprises: determining, for a conversion between a current frame of a video and a bitstream of the video, first information regarding when to synchronize encoding information of the video to a rate control for encoding the video, the first information being determined based on rate control information for encoding a set of frames of the video that is encoded before the current frame; and performing the conversion based on the first information.

Based on the method in accordance with the second aspect of the present disclosure, first information regarding when to synchronize encoding information is determined based on real-time rate control information. Compared with the conventional solution where the first information is fixed or predetermined, the proposed method can advantageously determine the first information adaptively, and thus achieve an appropriate balance between encoding speed and rate control performance. Thereby, the coding quality can be improved.

In a third aspect, another method for video processing is proposed. The method comprises: determining, for a conversion between a current frame of a video and a bitstream of the video, a first QP offset for a region of interest (ROI) in the current frame based on rate control information; determining a second QP offset for a non-ROI in the current frame based on the first QP offset; and performing the conversion based on the first QP offset and the second QP offset.

Based on the method in accordance with the third aspect of the present disclosure, the QP offsets for ROI and non-ROI are determined based on rate control information. Compared with the conventional solution, the proposed method can advantageously perform the rate control for ROI region and non-ROI region more accurately, and thus the bitrate can be controlled more accurately. Thereby, the coding quality can be improved.

In a fourth aspect, an apparatus for video processing is proposed. The apparatus comprises a processor and a non-transitory memory with instructions thereon. The instructions upon execution by the processor, cause the processor to perform a method in accordance with the first, second, or third aspect of the present disclosure.

In a fifth aspect, a non-transitory computer-readable storage medium is proposed. The non-transitory computer-readable storage medium stores instructions that cause a processor to perform a method in accordance with the first, second, or third aspect of the present disclosure.

In a sixth aspect, another non-transitory computer-readable recording medium is proposed. The non-transitory computer-readable recording medium stores a bitstream of a video which is generated by a method performed by an apparatus for video processing. The method comprises: determining rate control information for encoding a current block in a current frame of the video, the rate control information being determined at least based on information of a first set of blocks in the current frame that is encoded before the current block; and generating the bitstream based on the rate control information.

In a seventh aspect, another non-transitory computer-readable recording medium is proposed. The non-transitory computer-readable recording medium stores a bitstream of a video which is generated by a method performed by an apparatus for video processing. The method comprises: determining first information regarding when to synchronize encoding information of the video to a rate control for encoding the video, the first information being determined based on rate control information for encoding a set of frames of the video that is encoded before a current frame of the video; and generating the bitstream based on the first information.

In an eighth aspect, another non-transitory computer-readable recording medium is proposed. The non-transitory computer-readable recording medium stores a bitstream of a video which is generated by a method performed by an apparatus for video processing. The method comprises: determining a first QP offset for a region of interest (ROI) in a current frame of the video based on rate control information; determining a second QP offset for a non-ROI in the current frame based on the first QP offset; and generating the bitstream based on the first QP offset and the second QP offset.

In a ninth aspect, a method for storing a bitstream of a video is proposed. The method comprises: determining rate control information for encoding a current block in a current frame of the video, the rate control information being determined at least based on information of a first set of blocks in the current frame that is encoded before the current block; generating the bitstream based on the rate control information; and storing the bitstream in a non-transitory computer-readable recording medium.

In a tenth aspect, another method for storing a bitstream of a video is proposed. The method comprises: determining first information regarding when to synchronize encoding information of the video to a rate control for encoding the video, the first information being determined based on rate control information for encoding a set of frames of the video that is encoded before a current frame of the video; generating the bitstream based on the first information; and storing the bitstream in a non-transitory computer-readable recording medium.

In an eleventh aspect, another method for storing a bitstream of a video is proposed. The method comprises: determining a first QP offset for a region of interest (ROI) in a current frame of the video based on rate control information; determining a second QP offset for a non-ROI in the current frame based on the first QP offset; generating the bitstream based on the first QP offset and the second QP offset; and storing the bitstream in a non-transitory computer-readable recording medium.

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

### BRIEF DESCRIPTION OF THE DRAWINGS

Through the following detailed description with reference to the accompanying drawings, the above and other objectives, features, and advantages of example embodiments of the present disclosure will become more apparent. In the example embodiments of the present disclosure, the same reference numerals usually refer to the same components.

FIG. 1 illustrates a block diagram that illustrates an example video coding system, in accordance with some embodiments of the present disclosure;

FIG. 2 illustrates a block diagram that illustrates a first example video encoder, in accordance with some embodiments of the present disclosure;

FIG. 3 illustrates a block diagram that illustrates an example video decoder, in accordance with some embodiments of the present disclosure;

FIG. 4 illustrates an overview of HEVC standard;

FIG. 5A illustrates an example of splitting a picture into slices;

FIG. 5B illustrates an example of splitting a picture into tiles;

FIG. 6 illustrates an illustration of wavefront parallel processing;

FIG. 7 illustrates an illustration of the rate control in the encoder;

FIG. 8 illustrates several example ROIs for a frame of video games;

FIG. 9A illustrates a block-level rate control for WPP enabled scenario;

FIG. 9B illustrates a block-level rate control for multi-tile/slice scenario;

FIG. 10 illustrates a flowchart of a method for video processing in accordance with embodiments of the present disclosure;

FIG. 11 illustrates a flowchart of a method for video processing in accordance with embodiments of the present disclosure;

FIG. 12 illustrates a flowchart of a method for video processing in accordance with embodiments of the present disclosure; and

FIG. 13 illustrates a block diagram of a computing device in which various embodiments of the present disclosure can be implemented.

Throughout the drawings, the same or similar reference numerals usually refer to the same or similar elements.

### DETAILED DESCRIPTION

Principle of the present disclosure will now be described with reference to some embodiments. It is to be understood that these embodiments are described only for the purpose of illustration and help those skilled in the art to understand and implement the present disclosure, without suggesting any limitation as to the scope of the disclosure. The disclosure described herein can be implemented in various manners other than the ones described below.

In the following description and claims, unless defined otherwise, all technical and scientific terms used herein have the same meaning as commonly understood by one of ordinary skills in the art to which this disclosure belongs.

References in the present disclosure to “one embodiment,” “an embodiment,” “an example embodiment,” and the like indicate that the embodiment described may include a particular feature, structure, or characteristic, but it is not necessary that every embodiment includes the particular feature, structure, or characteristic. Moreover, such phrases are not necessarily referring to the same embodiment. Further, when a particular feature, structure, or characteristic is described in connection with an example embodiment, it is submitted that it is within the knowledge of one skilled in the art to affect such feature, structure, or characteristic in connection with other embodiments whether or not explicitly described.

It shall be understood that although the terms “first” and “second” etc. may be used herein to describe various elements, these elements should not be limited by these terms. These terms are only used to distinguish one element from another. For example, a first element could be termed a second element, and similarly, a second element could be termed a first element, without departing from the scope of example embodiments. As used herein, the term “and/or” includes any and all combinations of one or more of the listed terms.

The terminology used herein is for the purpose of describing particular embodiments only and is not intended to be limiting of example embodiments. As used herein, the singular forms “a”, “an” and “the” are intended to include the plural forms as well, unless the context clearly indicates otherwise. It will be further understood that the terms “comprises”, “comprising”, “has”, “having”, “includes” and/or “including”, when used herein, specify the presence of stated features, elements, and/or components etc., but do not preclude the presence or addition of one or more other features, elements, components and/or combinations thereof.

### Example Environment

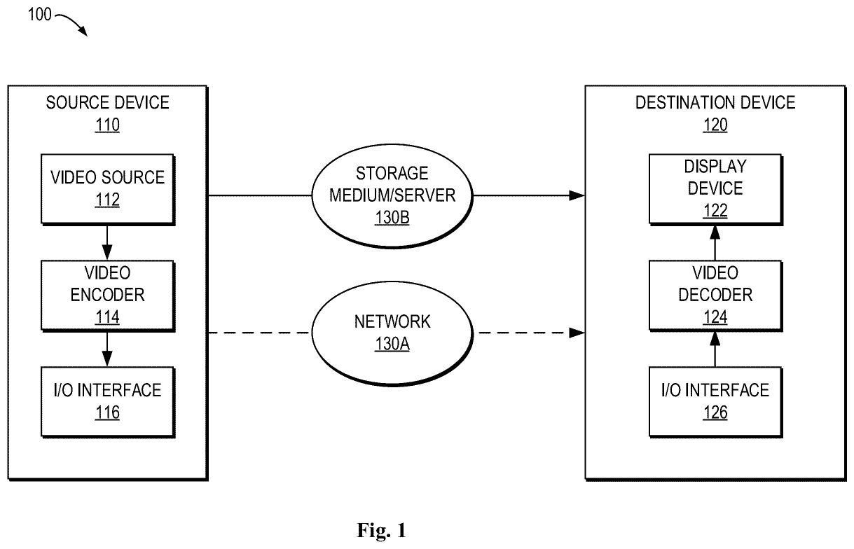

FIG. 1 is a block diagram that illustrates an example video coding system 100 that may utilize the techniques of this disclosure. As shown, the video coding system 100 may include a source device 110 and a destination device 120. The source device 110 can be also referred to as a video encoding device, and the destination device 120 can be also referred to as a video decoding device. In operation, the source device 110 can be configured to generate encoded video data and the destination device 120 can be configured to decode the encoded video data generated by the source device 110. The source device 110 may include a video source 112, a video encoder 114, and an input/output (I/O) interface 116.

The video source 112 may include a source such as a video capture device. Examples of the video capture device include, but are not limited to, an interface to receive video data from a video content provider, a computer graphics system for generating video data, and/or a combination thereof.

The video data may comprise one or more pictures. The video encoder 114 encodes the video data from the video source 112 to generate a bitstream. The bitstream may include a sequence of bits that form a coded representation of the video data. The bitstream may include coded pictures and associated data. The coded picture is a coded representation of a picture. The associated data may include sequence parameter sets, picture parameter sets, and other syntax structures. The I/O interface 116 may include a modulator/demodulator and/or a transmitter. The encoded video data may be transmitted directly to destination device 120 via the I/O interface 116 through the network 130A. The encoded video data may also be stored onto a storage medium/server 130B for access by destination device 120.

The destination device 120 may include an I/O interface 126, a video decoder 124, and a display device 122. The I/O interface 126 may include a receiver and/or a modem. The I/O interface 126 may acquire encoded video data from the source device 110 or the storage medium/server 130B. The video decoder 124 may decode the encoded video data. The display device 122 may display the decoded video data to a user. The display device 122 may be integrated with the destination device 120, or may be external to the destination device 120 which is configured to interface with an external display device.

The video encoder 114 and the video decoder 124 may operate according to a video compression standard, such as the High Efficiency Video Coding (HEVC) standard, Versatile Video Coding (VVC) standard and other current and/or further standards.

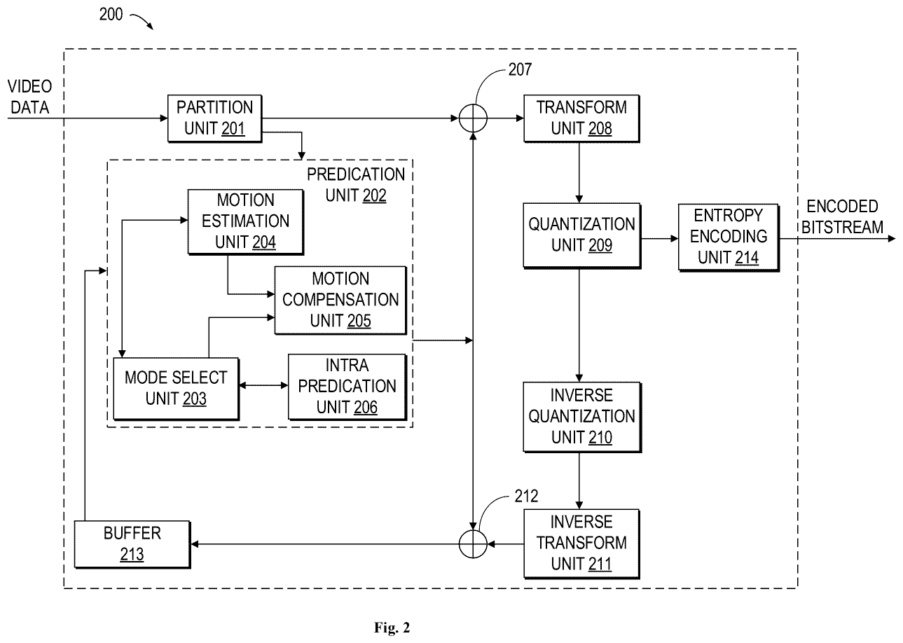

FIG. 2 is a block diagram illustrating an example of a video encoder 200, which may be an example of the video encoder 114 in the system 100 illustrated in FIG. 1, in accordance with some embodiments of the present disclosure.

The video encoder 200 may be configured to implement any or all of the techniques of this disclosure. In the example of FIG. 2, the video encoder 200 includes a plurality of functional components. The techniques described in this disclosure may be shared among the various components of the video encoder 200. In some examples, a processor may be configured to perform any or all of the techniques described in this disclosure.

In some embodiments, the video encoder 200 may include a partition unit 201, a predication unit 202 which may include a mode select unit 203, a motion estimation unit 204, a motion compensation unit 205 and an intra-prediction unit 206, a residual generation unit 207, a transform unit 208, a quantization unit 209, an inverse quantization unit 210, an inverse transform unit 211, a reconstruction unit 212, a buffer 213, and an entropy encoding unit 214.

In other examples, the video encoder 200 may include more, fewer, or different functional components. In an example, the predication unit 202 may include an intra block copy (IBC) unit. The IBC unit may perform predication in an IBC mode in which at least one reference picture is a picture where the current video block is located.

Furthermore, although some components, such as the motion estimation unit 204 and the motion compensation unit 205, may be integrated, but are represented in the example of FIG. 2 separately for purposes of explanation.

The partition unit 201 may partition a picture into one or more video blocks. The video encoder 200 and the video decoder 300 may support various video block sizes.

The mode select unit 203 may select one of the coding modes, intra or inter, e.g., based on error results, and provide the resulting intra-coded or inter-coded block to a residual generation unit 207 to generate residual block data and to a reconstruction unit 212 to reconstruct the encoded block for use as a reference picture. In some examples, the mode select unit 203 may select a combination of intra and inter predication (CIIP) mode in which the predication is based on an inter predication signal and an intra predication signal. The mode select unit 203 may also select a resolution for a motion vector (e.g., a sub-pixel or integer pixel precision) for the block in the case of inter-predication.

To perform inter prediction on a current video block, the motion estimation unit 204 may generate motion information for the current video block by comparing one or more reference frames from buffer 213 to the current video block. The motion compensation unit 205 may determine a predicted video block for the current video block based on the motion information and decoded samples of pictures from the buffer 213 other than the picture associated with the current video block.

The motion estimation unit 204 and the motion compensation unit 205 may perform different operations for a current video block, for example, depending on whether the current video block is in an I-slice, a P-slice, or a B-slice. As used herein, an “I-slice” may refer to a portion of a picture composed of macroblocks, all of which are based upon macroblocks within the same picture. Further, as used herein, in some aspects, “P-slices” and “B-slices” may refer to portions of a picture composed of macroblocks that are not dependent on macroblocks in the same picture.

In some examples, the motion estimation unit 204 may perform uni-directional prediction for the current video block, and the motion estimation unit 204 may search reference pictures of list 0 or list 1 for a reference video block for the current video block. The motion estimation unit 204 may then generate a reference index that indicates the reference picture in list 0 or list 1 that contains the reference video block and a motion vector that indicates a spatial displacement between the current video block and the reference video block. The motion estimation unit 204 may output the reference index, a prediction direction indicator, and the motion vector as the motion information of the current video block. The motion compensation unit 205 may generate the predicted video block of the current video block based on the reference video block indicated by the motion information of the current video block.

Alternatively, in other examples, the motion estimation unit 204 may perform bi-directional prediction for the current video block. The motion estimation unit 204 may search the reference pictures in list 0 for a reference video block for the current video block and may also search the reference pictures in list 1 for another reference video block for the current video block. The motion estimation unit 204 may then generate reference indexes that indicate the reference pictures in list 0 and list 1 containing the reference video blocks and motion vectors that indicate spatial displacements between the reference video blocks and the current video block. The motion estimation unit 204 may output the reference indexes and the motion vectors of the current video block as the motion information of the current video block. The motion compensation unit 205 may generate the predicted video block of the current video block based on the reference video blocks indicated by the motion information of the current video block.

In some examples, the motion estimation unit 204 may output a full set of motion information for decoding processing of a decoder. Alternatively, in some embodiments, the motion estimation unit 204 may signal the motion information of the current video block with reference to the motion information of another video block. For example, the motion estimation unit 204 may determine that the motion information of the current video block is sufficiently similar to the motion information of a neighboring video block.

In one example, the motion estimation unit 204 may indicate, in a syntax structure associated with the current video block, a value that indicates to the video decoder 300 that the current video block has the same motion information as the another video block.

In another example, the motion estimation unit 204 may identify, in a syntax structure associated with the current video block, another video block and a motion vector difference (MVD). The motion vector difference indicates a difference between the motion vector of the current video block and the motion vector of the indicated video block. The video decoder 300 may use the motion vector of the indicated video block and the motion vector difference to determine the motion vector of the current video block.

As discussed above, video encoder 200 may predictively signal the motion vector. Two examples of predictive signaling techniques that may be implemented by video encoder 200 include advanced motion vector predication (AMVP) and merge mode signaling.

The intra prediction unit 206 may perform intra prediction on the current video block. When the intra prediction unit 206 performs intra prediction on the current video block, the intra prediction unit 206 may generate prediction data for the current video block based on decoded samples of other video blocks in the same picture. The prediction data for the current video block may include a predicted video block and various syntax elements.

The residual generation unit 207 may generate residual data for the current video block by subtracting (e.g., indicated by the minus sign) the predicted video block (s) of the current video block from the current video block. The residual data of the current video block may include residual video blocks that correspond to different sample components of the samples in the current video block.

In other examples, there may be no residual data for the current video block for the current video block, for example in a skip mode, and the residual generation unit 207 may not perform the subtracting operation.

The transform processing unit 208 may generate one or more transform coefficient video blocks for the current video block by applying one or more transforms to a residual video block associated with the current video block.

After the transform processing unit 208 generates a transform coefficient video block associated with the current video block, the quantization unit 209 may quantize the transform coefficient video block associated with the current video block based on one or more quantization parameter (QP) values associated with the current video block.

The inverse quantization unit 210 and the inverse transform unit 211 may apply inverse quantization and inverse transforms to the transform coefficient video block, respectively, to reconstruct a residual video block from the transform coefficient video block. The reconstruction unit 212 may add the reconstructed residual video block to corresponding samples from one or more predicted video blocks generated by the predication unit 202 to produce a reconstructed video block associated with the current video block for storage in the buffer 213.

After the reconstruction unit 212 reconstructs the video block, loop filtering operation may be performed to reduce video blocking artifacts in the video block.

The entropy encoding unit 214 may receive data from other functional components of the video encoder 200. When the entropy encoding unit 214 receives the data, the entropy encoding unit 214 may perform one or more entropy encoding operations to generate entropy encoded data and output a bitstream that includes the entropy encoded data.

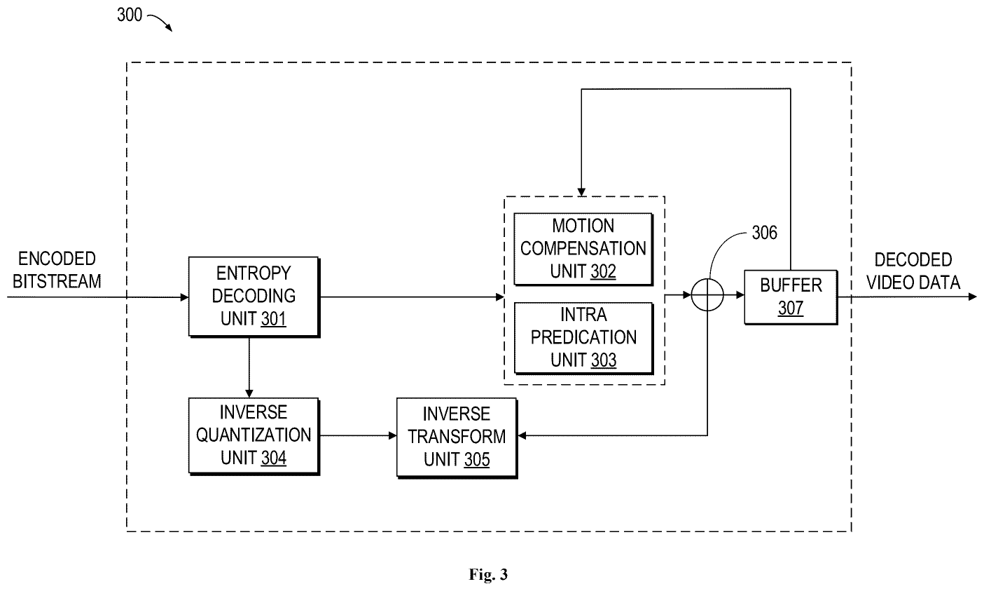

FIG. 3 is a block diagram illustrating an example of a video decoder 300, which may be an example of the video decoder 124 in the system 100 illustrated in FIG. 1, in accordance with some embodiments of the present disclosure.

The video decoder 300 may be configured to perform any or all of the techniques of this disclosure. In the example of FIG. 3, the video decoder 300 includes a plurality of functional components. The techniques described in this disclosure may be shared among the various components of the video decoder 300. In some examples, a processor may be configured to perform any or all of the techniques described in this disclosure.

In the example of FIG. 3, the video decoder 300 includes an entropy decoding unit 301, a motion compensation unit 302, an intra prediction unit 303, an inverse quantization unit 304, an inverse transformation unit 305, and a reconstruction unit 306 and a buffer 307. The video decoder 300 may, in some examples, perform a decoding pass generally reciprocal to the encoding pass described with respect to video encoder 200.

The entropy decoding unit 301 may retrieve an encoded bitstream. The encoded bitstream may include entropy coded video data (e.g., encoded blocks of video data). The entropy decoding unit 301 may decode the entropy coded video data, and from the entropy decoded video data, the motion compensation unit 302 may determine motion information including motion vectors, motion vector precision, reference picture list indexes, and other motion information. The motion compensation unit 302 may, for example, determine such information by performing the AMVP and merge mode. AMVP is used, including derivation of several most probable candidates based on data from adjacent PBs and the reference picture. Motion information typically includes the horizontal and vertical motion vector displacement values, one or two reference picture indices, and, in the case of prediction regions in B slices, an identification of which reference picture list is associated with each index. As used herein, in some aspects, a “merge mode” may refer to deriving the motion information from spatially or temporally neighboring blocks.

The motion compensation unit 302 may produce motion compensated blocks, possibly performing interpolation based on interpolation filters. Identifiers for interpolation filters to be used with sub-pixel precision may be included in the syntax elements.

The motion compensation unit 302 may use the interpolation filters as used by the video encoder 200 during encoding of the video block to calculate interpolated values for sub-integer pixels of a reference block. The motion compensation unit 302 may determine the interpolation filters used by the video encoder 200 according to the received syntax information and use the interpolation filters to produce predictive blocks.

The motion compensation unit 302 may use at least part of the syntax information to determine sizes of blocks used to encode frame(s) and/or slice(s) of the encoded video sequence, partition information that describes how each macroblock of a picture of the encoded video sequence is partitioned, modes indicating how each partition is encoded, one or more reference frames (and reference frame lists) for each inter-encoded block, and other information to decode the encoded video sequence. As used herein, in some aspects, a “slice” may refer to a data structure that can be decoded independently from other slices of the same picture, in terms of entropy coding, signal prediction, and residual signal reconstruction. A slice can either be an entire picture or a region of a picture.

The intra prediction unit 303 may use intra prediction modes for example received in the bitstream to form a prediction block from spatially adjacent blocks. The inverse quantization unit 304 inverse quantizes, i.e., de-quantizes, the quantized video block coefficients provided in the bitstream and decoded by entropy decoding unit 301. The inverse transform unit 305 applies an inverse transform.

The reconstruction unit 306 may obtain the decoded blocks, e.g., by summing the residual blocks with the corresponding prediction blocks generated by the motion compensation unit 302 or intra-prediction unit 303. If desired, a deblocking filter may also be applied to filter the decoded blocks in order to remove blockiness artifacts. The decoded video blocks are then stored in the buffer 307, which provides reference blocks for subsequent motion compensation/intra predication and also produces decoded video for presentation on a display device.

Some exemplary embodiments of the present disclosure will be described in detailed hereinafter. It should be understood that section headings are used in the present document to facilitate ease of understanding and do not limit the embodiments disclosed in a section to only that section. Furthermore, while certain embodiments are described with reference to Versatile Video Coding or other specific video codecs, the disclosed techniques are applicable to other video coding technologies also. Furthermore, while some embodiments describe video coding steps in detail, it will be understood that corresponding steps decoding that undo the coding will be implemented by a decoder. Furthermore, the term video processing encompasses video coding or compression, video decoding or decompression and video transcoding in which video pixels are represented from one compressed format into another compressed format or at a different compressed bitrate.

### 1 Brief Summary

This disclosure is related to video encoding technologies. Specifically, it is related to the rate control module design in video encoding. It may be applied to existing video encoders, such as x264, x265, HM, VVenC, VTM and others. It may also be applicable to future video coding encoders or video codecs.

### 2 Introduction

### 2.1 High Efficiency Video Coding (HEVC) Standard

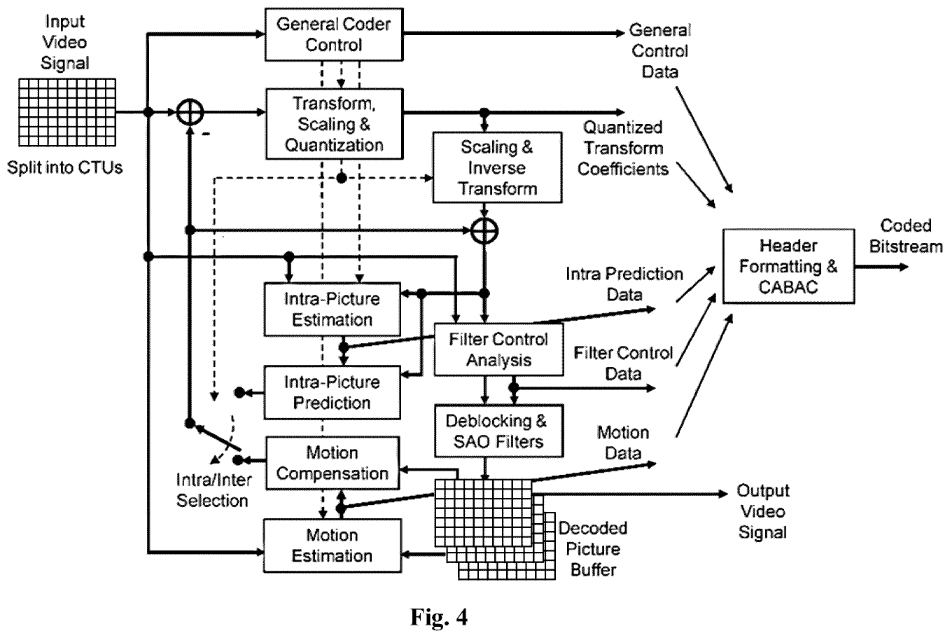

FIG. 4 depicts the block diagram of a hybrid video encoder, including block partitions that split the video picture into CTUs. For each CTU, it is divided into several blocks, called coding units, using quad-tree and binary tree structures. For each coding unit, block-based intra or inter prediction is performed, and the resulting residues are transformed and quantized. Finally, Context-Adaptive Binary Arithmetic Coding (CABAC) entropy coding is employed for bitstream generation.

### 2.2 Slice and Tile

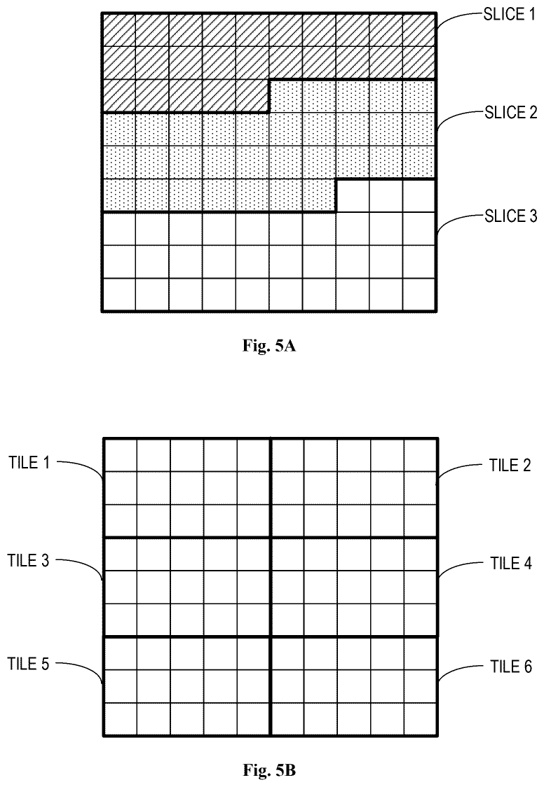

A slice is a series of CTUs processed in raster scan order, which is a data structure that can be decoded independently of other slices of the same picture in terms of entropy encoding, signal prediction, and residual signal reconstruction. A picture may be divided into one or more slices. FIG. 5A illustrates an example of splitting a picture into slices. As shown in FIG. 5A, the picture is divided into three slices. One of the main purposes of slices is to resynchronize in the event of data loss. Given the availability of the active sequence and picture parameter set, the syntax elements of slices can be parsed from the bitstream, and sample values in the picture area represented by the slice can be correctly decoded without using any data from other slices in the same picture. This means that predictions within a picture, such as in-picture spatial signal prediction or motion vector prediction, are not performed across tile boundaries. However, some information from other slices may be required to apply in-loop filtering across slice boundaries.

In addition to slices, HEVC also defines tiles, which are self-contained and independently decodable rectangular regions of the picture. The main purpose of tiles is to enable the use of parallel processing architectures for encoding and decoding. Multiple tiles may share header information by being contained in the same slice. Alternatively, a single tile may contain multiple slices. A tile consists of a rectangular arranged group of CTUs. FIG. 5B illustrates an example of splitting a picture into tiles. As shown in FIG. 5B, the picture is divided into six tiles with all of them containing about the same number of CTUs. Each tile must be at least 256 luma samples wide and 64 luma samples tall. It's typically but not necessarily that the size of all the tiles in a picture are same.

### 2.3 Wavefront Parallel Processing (WPP)

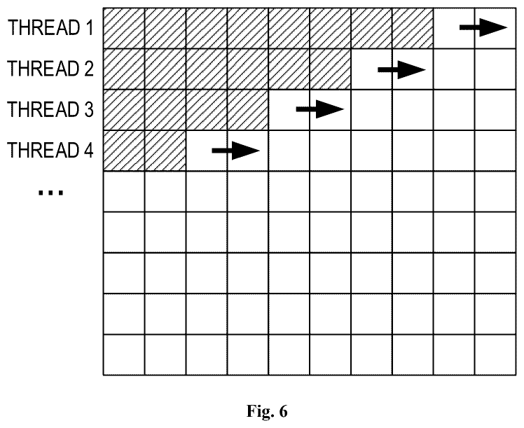

WPP is a new parallel processing in H.265/HEVC, which provides a form of processing parallelism at a CTU-row level of granularity. FIG. 6 illustrates an illustration of wavefront parallel processing. As it shown in FIG. 6, a slice is divided into rows of CTUs when WPP is enabled. The first row is processed in an ordinary way, and the second row can begin to be processed after only two CTUs have been processed in the first row, then the third row can begin to be processed after only two CTUs have been processed in the second row, and so on. The context model for the entropy encoder in each row is inferred from the previous row with a processing delay of two CTUs. Once some of the decisions required to predict and adapt to the entropy encoder in the previous line have been made, the decoding of each row can be begun. This enables parallel processing of CTU lines by using multiple processing threads in the encoder or decoder.

For design simplicity, WPP is not allowed to be used in combination with tiles. In other word, when an encoder encodes a picture using multiple tiles, it cannot also use wavefront parallel processing. WPP may often provide better compression performance and speed than multiple tiles. However, for some new complex scenarios such as VR and 8K, multiple tiles processing with MCTS is more effective than WPP. The main function of MCTS is to eliminate the strong dependence between tiles by making certain restrictions on the encoding conditions and the encoding process of tiles, so that it can meet the independent decoding of a randomly selected set of tiles.

### 2.4 Rate Control

Although channel bandwidth capabilities are increasing, as current video communication applications become more complex such as VR, 8K, HDR, the channel bandwidth is still limited. In order to transmit a video stream over a constant rate channel with appropriate picture quality, the bit rate must be controlled and allocated appropriately.

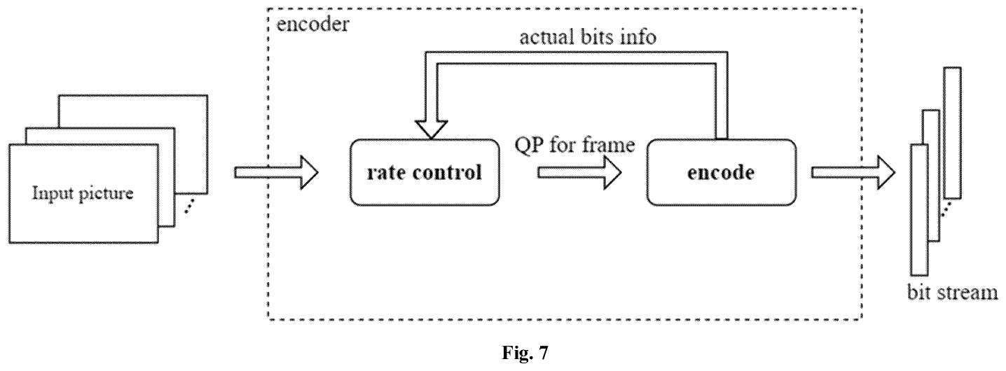

Rate control is an important tool to deal with bit rate and compressed video quality fluctuations, which aims to achieve good perceptual quality given the transmission bandwidth constraint. FIG. 7 illustrates an illustration of the rate control in the encoder. FIG. 7 simply describes the role of rate control in the encoder. Rate control outputs a suitable QP for a frame by performing bit rate estimation on the input picture under the condition of limited bandwidth, and the encoder encodes under the corresponding QP and outputs the bit stream, the actual bit stream information is fed back to the rate control to update the bit rate estimation model to make the code rate estimation more accurate.

### 3 Problems

The current rate control design has the following problems:

1. The bitrate estimation model is not accurate enough in parallel encoding with multi-threading complex scenarios, and the actual bitrate of the encoding is quite different from the predicted bitrate, resulting in the inability to accurately control the real-time status of the encoding and the situation where the instantaneous bitrate cannot be accurately controlled.

2. Encoded information synchronization plays an important role in rate control, which can predict bit rate information more accurately through the feedback of real-time encoding information. However, frequent synchronization of information in multi-threading reduces parallelism efficiency and lower encoding speed. Finding a balance between encoding speed and rate control performance is very important, especially in complex scenarios, such as VR, 4K, 8K, etc.

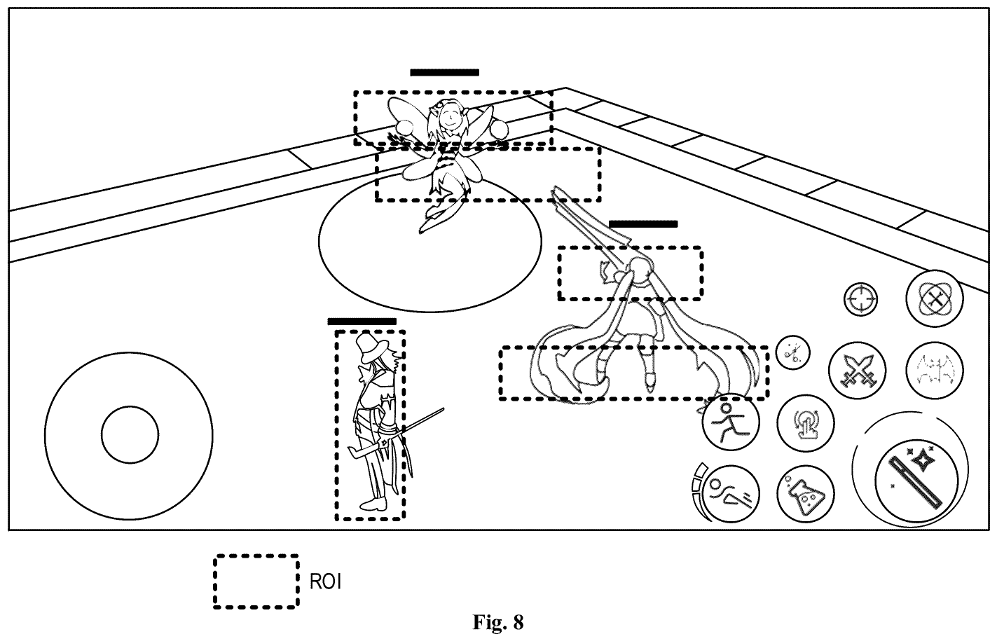

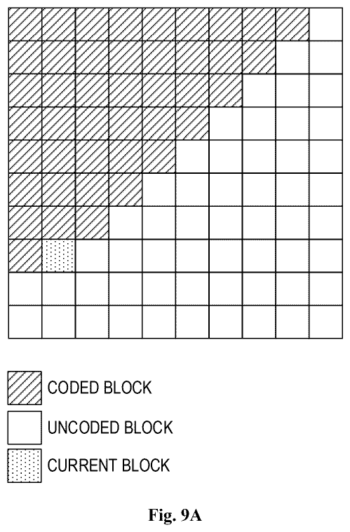

3. ROI is a very common algorithm to enhance the subjective quality of video in code control, but as video scenarios become more and more complex, existing ROI algorithms cannot be applied to all scenarios. For scenes similar to football games, basketball games or video games, the number of ROIs in a picture is large and each ROI area is relatively small, as shown in FIG. 8, which causes the bitrate estimation in the ROI area to be inaccurate and the ROI effect is not limited.

### 4 Detail Solutions

To solve the above problems and some other problems not mentioned, methods as summarized below are disclosed. These embodiments should be considered as examples to explain the general concepts and should not be interpreted in a narrow way. Furthermore, these embodiments can be applied individually or combined in any manner.

It should be noticed that rate control may represent the design in the prior art, alternatively, it could represent any variances of the rate control design in the prior art or other kinds of rate control methods.

### Block-Level Rate Control in Parallel Encoding Scenarios

Block-level rate control is mainly to adjust the QP of blocks in units of code block in a timely manner, so that the bitrate of a frame is as close as possible to the predicted bitrate of frame-level rate control.

Let Bᵢ be the actual coded bits of the block Uᵢ. Let Rᵢ be the total coded bits before current block is encoded.

Let Cᵢ be the original complexity of the block Uᵢ.

Let ELBⱼ be the estimated bits for those left uncoded blocks before current block Uⱼ is encoded.

Let ETBⱼ be the total estimated bits for current frame/tile before current block Uⱼ is encoded, which is updated with the encoding.

Let TETBₖ be the target bits of the current tile k estimated by rate control, let MAXTBₖ be the maximum bitrate that rate control can tolerate the tile k, let MINTBₖ the minimum bitrate that rate control can tolerate the tile k.

Let est_frame_bits be the target bits of the current frame estimated by rate control, let max_frame_bits be the maximum bitrate that rate control can tolerate the current frame, let min_frame_bits the minimum bitrate that rate control can tolerate the current frame. Where min_frame_bits<=est_frame_bits<=max_frame_bits.

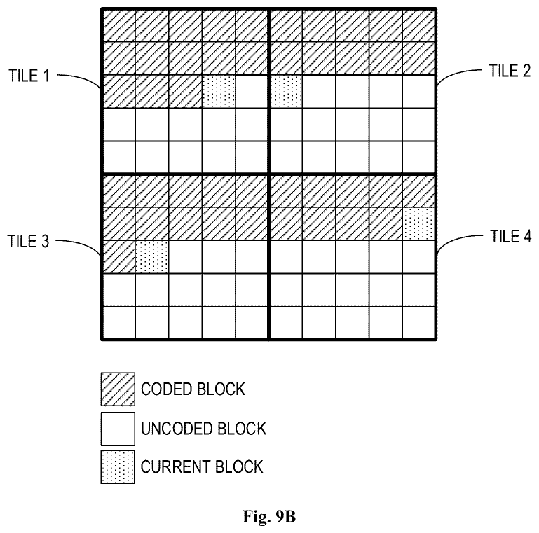

FIG. 9A illustrates a block-level rate control for WPP enabled scenarios. FIG. 9B illustrates a block-level rate control for multi-tile/slice scenarios.
1. The decision of block-level rate control may depend on the information of coded blocks, e.g., the actual bits of coded blocks.
   a. In one example, the actual bits and the weighted complexity of coded blocks may be dependent on the encode order of blocks in a frame.
      i. In one example, the top and right-top blocks of current block must be coded for WPP enabled scenarios, and the bullets may be illustrated by FIG. 9A.
      ii. In one example, the pre-blocks of current block in each tile must be coded for multi-tile scenarios, and the bullets may be illustrated by FIG. 9B.
   b. In one example, the actual bits and the weighted complexity of coded blocks may be dependent on the location of the current block in a frame/tile.
   c. In one example, the coded bits so far may be calculated with sum of actual coded blocks bits associated with the encode order of blocks in a frame/tile.
   d. In one example, the left weighted complexity so far to be checked for current block may be calculated with coded weighted complexity and total weighted complexity of frame/tile.
   e. In one example, the target left bits range so far to be checked for the left blocks may be calculated with the coded bits so far and the total target frame/tile bits.
   f. In one example, the estimated left bits so far to be checked for the left blocks may be calculated with a linear function of coded bits and coded weighted complexity and left weighted complexity of frame/tile.
   g. In one example, the estimated total bits so far to be checked for the whole frame may be calculated by the coded bits and the estimated left bits.
   h. In one example, Rᵢ may include Cᵢ and Bᵢ.
      i. In one example, Rᵢ may be evaluated as (Σ_{i∈coded blocks} Bᵢ)/(Σ_{i∈coded blocks}Wᵢ*Cᵢ).
         1. In one example, W₀, W₁ . . . Wₛ may have same or different values, which depends on the other encode tools such as cu-tree dan so on.
      ii. In one example, Cᵢ. may be calculated using a distortion metric in pre-analysis process, such as sum of absolute differences (SAD), sum of squared error (SSE) or mean sum of squared error (MSE).
   i. In one example, ELBⱼ may include Rⱼ and Cⱼ, ELBⱼ may be evaluated as Rⱼ*(Σ_{j∈coded blocks}Wⱼ*Cⱼ).
   j. In one example, ETBⱼ may include ELBⱼ and Bⱼ, ETBⱼ may be evaluated as (Σ_{j∈coded blocks}Bⱼ)+ELBⱼ.
   k. In one example, TETBₖ may include Cⱼ and est_frame_bits, TETBₖ may be evaluated as est_frame_bits*(Σ_{j∈tile k}WⱼCⱼ)/(Σ_{j∈current frame} WⱼCⱼ).
   l. In one example, MAXTBₖ may include Cⱼ and max_frame_bits, TETBₖ may be evaluated as max_frame_bits*(Σ_{j∈tile k}WⱼCⱼ)/(Σ_{j∈current frame}WⱼCⱼ).
   m. In one example, MINTBₖ may include Cⱼ and min_frame_bits, TETBₖ may be evaluated as min_frame_bits*(Σ_{j∈tile k}WⱼCⱼ)/(Σ_{j∈current frame}WⱼCⱼ).
   n. In one example, different QP adjust methods may be employed for different states of code blocks.
      i. In one example, it will not adjust the QP when ETBⱼ is in the range of min_frame_bits/MINTBₖ and max_frame_bits/MAXTBₖ. Which is seen as being in line with expectations.
      ii. In one example, ETBⱼ may be larger than the max_frame_bits/MAXTBₖ, and it will turn up the QP to prevent the encoding bitrate from being exceeded.
      iii. In one example, ETBⱼ may be smaller than the min_frame_bits/MINTBₖ, and it will turn down the QP to prevent the bit rate is too low to affect the encoding quality.

### Adaptive Rate Control Synchronization in Parallel Encoding Scenarios

2. When to synchronize encoding information under multi-threading may depend on the real-time code control status.
   a. In one example, a maximum synchronization interval is set in rate control.
   b. In one example, the smallest QP and the largest QP may be marked and updated frame by frame between two adjacent synchronization points.
   c. In one example, the encoded information may be synchronized when the QP drops significantly from the smallest QP marked.
   d. In one example, the encoded information may be synchronized when the QP becomes significantly larger compared to the largest QP marked.
   e. In one example, the historical weighted average QP may be taken into account.
   f. In one example, the encoded information may be synchronized in the case of continuous low QP and the historical average QP is small enough.
   g. In one example, the encoded information may be synchronized in the case of continuous high QP and the historical average QP is big enough.

### ROI for Some Specific Scenarios

In the following bullets, let CRₖ be the complexity for ROI. Let CNRₖ the complexity for Non-ROI.

Let WCRₖ be the weighted complexity by QP offset for ROT. Let WCNRₖ the weighted complexity by QP offset for Non-ROI.

Let max_qp_offset be the max QP offset of ROT. Let max_qp_gap be the max QP gap of ROI and Non-ROI.

Let f(QP) be the linear function of delta QP to complexity. Let g(C) be the linear function of complexity to delta QP.
3. In the rate control process, the delta QP derived for each ROI and Non-ROI may include rate control information.
   a. In one example, the weighted complexity for ROI may be calculated with a linear function of delta QP to complexity.
   b. In one example, the delta QP derived Non-ROI may be calculated with a linear function of complexity to delta QP.
   c. In one example, the total complexity of ROI and Non-ROI in a frame is constant.
   d. In one example, WCRₖ may include CRₖ and ΔQP for ROI.
      i. In one example, WCRₖ may be evaluated as CRₖ*f(ΔQP).
   e. In one example, ΔQP for Non-ROI may include CNRₖ and WCNRₖ.
      i. In one example, ΔQP for Non-ROI may be evaluated as g (CNRₖ, WCNRₖ).
   f. the left weighted complexity so far to be checked for current block may be calculated with coded weighted complexity and total weighted complexity.
   g. In one example, ΔQP for ROI may be restricted by max_qp_offset.
   h. In one example, ΔQP for ROI and Non-ROI may be restricted by max_qp_gap.

### General Aspects

4. The above bullets could be applied to any scenarios, not limited to one scenario.
5. The above bullets could be applied to rate control module.

More details of the embodiments of the present disclosure will be described below which are related to rate control design. The embodiments of the present disclosure should be considered as examples to explain the general concepts and should not be interpreted in a narrow way. Furthermore, these embodiments can be applied individually or combined in any manner.

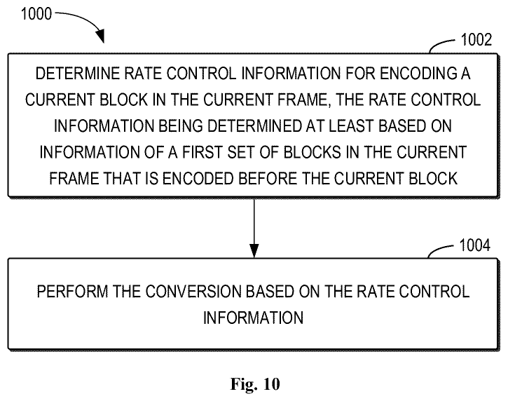

FIG. 10 illustrates a flowchart of a method 1000 for video processing in accordance with some embodiments of the present disclosure. The method 1000 may be implemented during a conversion between a current frame of a video and a bitstream of the video. In some embodiments, the proposed method 1000 may be implemented by a rate control module or the like.

As shown in FIG. 10, the method 1000 starts at 1002 where rate control information for encoding a current block in the current frame is determined at least based on information of a first set of blocks in the current frame that is encoded before the current block. By way of example, the rate control information may comprise a quantization parameter (QP) and/or the like. Moreover, the information of the first set of blocks may comprises the actual number of bits for encoding the first set of blocks. This will be describe in details below.

As used herein, the term “block” may represent a coding tree unit (CTU), a coding unit (CU), a prediction unit (PU), a transform unit (TU), a coding tree block (CTB), a coding block (CB), a prediction block (PB), a transform block (TB), a sub-block of a video block, a sub-region within a video block, a video processing unit comprising multiple samples/pixels, and/or the like. A block may be rectangular or non-rectangular.

In some embodiments, the current frame may be encoded based on a parallel processing scheme in which the current frame is encoded based on at least one processing unit. In addition, the first set of blocks and the current block may be comprised in the same processing unit of the video.

In one example embodiments, the parallel processing scheme may be wavefront parallel processing (WPP), as shown in FIGS. 6 and 9A. In this case, the at least one processing unit may be the current frame. With reference to FIG. 9A, the first set of blocks may comprise all of coded blocks in the frame.

In another example embodiments, the parallel processing scheme may be multi-tile parallel processing, as shown in FIG. 9B. In this case, the at least one processing unit may be a plurality of tiles in the current frame. With reference to FIG. 9B, the first set of blocks may comprise all of coded blocks in a tile.

It should be understood that the possible implementations of the parallel processing scheme described above are merely illustrative and therefore should not be construed as limiting the present disclosure in any way. Moreover, in addition to the parallel processing scenario, the proposed method may also be applied to any other suitable scenarios.

At 1004, the conversion is performed based on the rate control information. In some embodiments, the conversion may include encoding the current frame into the bitstream. It should be understood that the above illustrations and/or examples are described merely for purpose of description. The scope of the present disclosure is not limited in this respect.

In view of the above, rate control information is determined for a block in a frame based on information of previously coded block(s). In other words, the rate control is performed at a block level. Compared with the conventional solution where the rate control is performed at a frame level, the proposed method can advantageously perform the rate control at a smaller granularity, and thus the bitrate can be controlled more accurately. Thereby, the coding quality can be improved.

In some embodiments, the information of the first set of blocks may further comprise a weighted complexity of the first set of blocks. In one example, the actual number of bits for encoding the first set of blocks and the weighted complexity of the first set of blocks may be dependent on an encoding order of blocks. For example, if the parallel processing scheme is the wavefront parallel processing, the first set of blocks comprises top blocks and left-top blocks of the current block, as shown in FIG. 9A. If the parallel processing scheme is the multi-tile parallel processing, the first set of blocks comprises blocks preceding the current block in each tile, as shown in FIG. 9B. Additionally or alternatively, the actual number of bits for encoding the first set of blocks and the weighted complexity of the first set of blocks may be dependent on a location of the current block.

In some embodiments, the actual number of bits for encoding the first set of blocks may be determined based on a sum of the actual number of bits for encoding each of the first set of blocks. For example, the actual number of bits for encoding the first set of blocks may be determined to be the sum of the actual number of bits for encoding each of the first set of blocks.

In some embodiments, the rate control information may be determined further based on a weighted complexity of a second set of blocks to be encoded. The second set of blocks and the first set of blocks may be in the same processing unit of the video. In one example, with reference to FIG. 9A, the second set of blocks may comprise the current block and all of uncoded blocks in the frame. Alternatively, the second set of blocks may comprise all of uncoded blocks in the frame. In another example, with reference to FIG. 9B, the second set of blocks may comprise the current block and all of uncoded blocks in a tile. Alternatively, the second set of blocks may comprise all of uncoded blocks in the tile.

In some embodiments, the weighted complexity of the second set of blocks may be determined based on the weighted complexity of the first set of blocks and a weighted complexity of a current processing unit comprising the current block. In one example, with reference to FIG. 9A, the current processing unit may be a frame. In another example, wither reference to FIG. 9B, the current processing unit may be a tile.

For example, the weighted complexity of the second set of blocks may be determined based on a result of subtracting the weighted complexity of the first set of blocks from the weighted complexity of the current processing unit. For example, the weighted complexity of the second set of blocks may be determined to be the result of subtracting the weighted complexity of the first set of blocks from the weighted complexity of the current processing unit.

In some embodiments, the rate control information may be determined further based on a target range of the number of bits for encoding the second set of blocks. For example, the target range of the number of bits for encoding the second set of blocks may be determined based on the actual number of bits for encoding the first set of blocks and the target number of bits for encoding a current processing unit comprising the current block. By way of example, the target range of the number of bits for encoding the second set of blocks may be determined based on a result of subtracting the actual number of bits for encoding the first set of blocks from the target number of bits for encoding the current processing unit.

In a case where the parallel processing scheme is multi-tile parallel processing, the target number of bits for encoding the current processing unit (i.e., the current tile) may be determined as follows:

$$TETB = estfb * ( {\sum }_{j ∈ N} {W}_{j} {C}_{j} ) / ( {\sum }_{j ∈ M} {W}_{j} {C}_{j} )$$

where TETB represents the target number of bits for encoding the current processing unit, estfb represents the target number of bits for encoding the current frame, Wⱼ represents a weight for a block with an index j, Cⱼ represents a complexity of a block with an index j, and N represents all blocks of the current processing unit, and M represents all blocks of the current frame.

In some embodiments, the rate control information may be determined further based on a first prediction for the number of bits for coding the second set of blocks. For example, the first prediction may be determined based on the actual number of bits for encoding the first set of blocks, the weighted complexity of the first set of blocks, and the weighted complexity of the second set of blocks. By way of example, the first prediction may be determined based on a linear function of the actual number of bits for encoding the first set of blocks, the weighted complexity of the first set of blocks, and the weighted complexity of the second set of blocks.

In some embodiments, the first prediction may be determined as follows:

$$ELB = R * ( {\sum }_{i ∈ Ω} {W}_{i} * {C}_{i} )$$

$$R = ( {\sum }_{i ∈ Ω} {B}_{i} ) / ( {\sum }_{i ∈ Ω} {W}_{i} * {C}_{i} )$$

where ELB represents the first prediction, Wᵢ represents a weight for a block with an index i, Cᵢ represents a complexity of a block with an index i, Bᵢ represents the actual number of bits for coding a block with an index i, and Ω represents the first set of blocks.

In some embodiments, a plurality of weights for weighting complexity of a plurality of blocks may be the same. Alternatively, at least two of the plurality of weights may be different from each other. Additionally or alternatively, the complexity of a block with an index i may be determined based on a distortion metric. By way of example, the distortion metric may comprise a sum of absolute differences (SAD), a sum of squared error (SSE), a mean sum of squared error (MSE), and/or the like.

In some embodiments, the rate control information may be determined further based on a second prediction for the number of bits for encoding a current processing unit comprising the current block. For example, the second prediction may be determined based on the actual number of bits for encoding the first set of blocks and the first prediction. By way of example, the second prediction may be determined based on a sum of the actual number of bits for encoding the first set of blocks and the first prediction.

In some embodiments, at 1002, the rate control information for encoding the current block is generated based on the second prediction and a rate control information for encoding a first block in the first set of blocks. By way of example rather than limitation, the rate control information may be a quantization parameter. If the second prediction is smaller than a first threshold, the quantization parameter for encoding the current block is determined by decreasing the quantization parameter for encoding the first block. If the second prediction is larger than a second threshold, the quantization parameter for encoding the current block is determined by increasing the quantization parameter for encoding the first block. If the second prediction is within a range from the first threshold to the second threshold, the quantization parameter for encoding the current block is determined as the quantization parameter for encoding the first block.

In some embodiments, the first threshold may be the minimum allowed number of bits for encoding the current processing unit. In addition, the second threshold may be the maximum allowed number of bits for encoding the current processing unit.

In a case where the parallel processing scheme is multi-tile parallel processing, the minimum allowed number of bits for encoding the current processing unit (i.e., the current tile) and the maximum allowed number of bits for encoding the current processing unit (i.e., the current tile) may be determined as follows:

$$Max TB = max fb * ( {\sum }_{j ∈ N} {W}_{j} {C}_{j} ) / ( {\sum }_{j ∈ M} {W}_{j} {C}_{j} )$$

$$MIN TB = min fb * ( {\sum }_{j ∈ N} {W}_{j} {C}_{j} ) / ( {\sum }_{j ∈ M} {W}_{j} {C}_{j} )$$

where MAXTB represents the maximum allowed number of bits for encoding the current processing unit, maxfb represents the maximum allowed number of bits for encoding the current frame, Wⱼ represents a weight for a block with an index j, Cⱼ represents a complexity of a block with an index j, and N represents all blocks of the current processing unit, and M represents all blocks of the current frame.

In view of the above, the solutions in accordance with some embodiments of the present disclosure can advantageously improve coding efficiency and coding quality.

According to further embodiments of the present disclosure, a non-transitory computer-readable recording medium is provided. The non-transitory computer-readable recording medium stores a bitstream of a video which is generated by a method performed by an apparatus for video processing. In the method, rate control information for encoding a current block in a current frame of the video is determined at least based on information of a first set of blocks in the current frame that is encoded before the current block. Moreover, the bitstream is generated based on the rate control information.

According to still further embodiments of the present disclosure, a method for storing bitstream of a video is provided. In the method, rate control information for encoding a current block in a current frame of the video is determined at least based on information of a first set of blocks in the current frame that is encoded before the current block. Moreover, the bitstream is generated based on the rate control information, and stored in a non-transitory computer-readable recording medium.

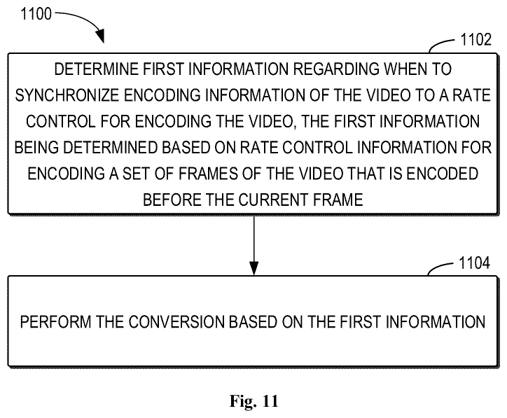

FIG. 11 illustrates a flowchart of a method 1100 for video processing in accordance with some embodiments of the present disclosure. The method 1100 may be implemented during a conversion between a current frame of a video and a bitstream of the video. In some embodiments, the proposed method 1100 may be implemented by a rate control module or the like.

As shown in FIG. 11, the method 1100 starts at 1102 where first information regarding when to synchronize encoding information of the video to a rate control for encoding the video is determined based on rate control information for encoding a set of frames of the video that is encoded before the current frame.

In some embodiments, the current frame may be encoded based on a parallel processing scheme in which the current frame is encoded based on at least one processing unit. In one example embodiments, the parallel processing scheme may be wavefront parallel processing (WPP), as shown in FIGS. 6 and 9A. In another example embodiments, the parallel processing scheme may be multi-tile parallel processing, as shown in FIG. 9B. It should be understood that the possible implementations of the parallel processing scheme described above are merely illustrative and therefore should not be construed as limiting the present disclosure in any way. Moreover, in addition to the parallel processing scenario, the proposed method may also be applied to any other suitable scenarios.

In some embodiments, the rate control information may comprise the smallest base QP since the latest synchronization point where the encoding information is synchronized. As used herein, a base QP may refer to a QP used for encoding a frame of the video. In one example embodiments, the entire frame is encoded with the base QP. In another example embodiments, the base QP may be adjusted for different parts of a frame. For example, a part of the frame may be encoded with a QP larger than the base QP, while the rest of the frame may be encoded with a QP smaller than the base QP.

For example, the encoding information may be synchronized when the QP drops significantly from the smallest QP. By way of example, if a base QP for encoding the current frame is smaller than the smallest base QP and a difference between the base QP and the smallest base QP is larger than a threshold, the base QP may be regard as dropping significantly from the smallest QP, and then the encoding information may be synchronized to the rate control.

In some additional or alternative embodiments, the rate control information may comprise the largest base QP since the latest synchronization point where the encoding information may be synchronized. For example, the encoding information may be synchronized when the QP becomes significantly larger compared to the largest QP. By way of example, if the base QP for encoding the current frame is larger than the largest base QP and a difference between the base QP and the largest base QP is larger than a threshold, the base QP may be regard as being significantly larger compared to the largest QP, and then the encoding information may be synchronized to the rate control.

At 1104, the conversion is performed based on the first information. In some embodiments, the conversion may include encoding the current frame into the bitstream. It should be understood that the above illustrations and/or examples are described merely for purpose of description. The scope of the present disclosure is not limited in this respect.

In view of the above, first information regarding when to synchronize encoding information is determined based on real-time rate control information. Compared with the conventional solution where the first information is fixed or predetermined, the proposed method can advantageously determine the first information adaptively, and thus achieve an appropriate balance between encoding speed and rate control performance. Thereby, the coding quality can be improved.

In some embodiments, the encoding information may be synchronized based on a maximum synchronization interval for synchronizing the encoding information. In other words, a difference between two adjacent synchronization point is not allowed to be larger than the maximum synchronization interval.

In some embodiments, the rate control information may comprise a historical weighted average base QP or a historical average base QP. By way of example rather than limitation, the historical weighted average base QP or the historical average base QP may be determined based on base QPs for encoding a predetermined number (such as 3, 5, 10 or the like) of frames encoded before the current frame.

In some embodiments, the encoding information may be synchronized if all of the following conditions are met: 1) each of base QPs for encoding a first plurality of frames in the set of frames is smaller than a third threshold, 2) the number of the first plurality of frames is larger than a predetermined number, and 3) a historical average base QP is smaller than a fourth threshold. That is, the encoding information may be synchronized in the case of continuous low base QP and the historical average base QP being small enough.

Additionally or alternatively, the encoding information may be synchronized if all of the following conditions are met: 1) each of base QPs for encoding a second plurality of frames in the set of frames is larger than a fifth threshold, 2) the number of the second plurality of frames is larger than a predetermined number, and 3) a historical average base QP is larger than a sixth threshold. That is, the encoding information may be synchronized in the case of continuous high base QP and the historical average base QP being big enough.

In view of the above, the solutions in accordance with some embodiments of the present disclosure can advantageously improve coding efficiency and coding quality.

According to further embodiments of the present disclosure, a non-transitory computer-readable recording medium is provided. The non-transitory computer-readable recording medium stores a bitstream of a video which is generated by a method performed by an apparatus for video processing. In the method, first information regarding when to synchronize encoding information of the video to a rate control for encoding the video is determined based on rate control information for encoding a set of frames of the video that is encoded before a current frame of the video. Moreover, the bitstream is generated based on the first information.

According to still further embodiments of the present disclosure, a method for storing bitstream of a video is provided. In the method, first information regarding when to synchronize encoding information of the video to a rate control for encoding the video is determined based on rate control information for encoding a set of frames of the video that is encoded before a current frame of the video. Moreover, the bitstream is generated based on the first information, and stored in a non-transitory computer-readable recording medium.

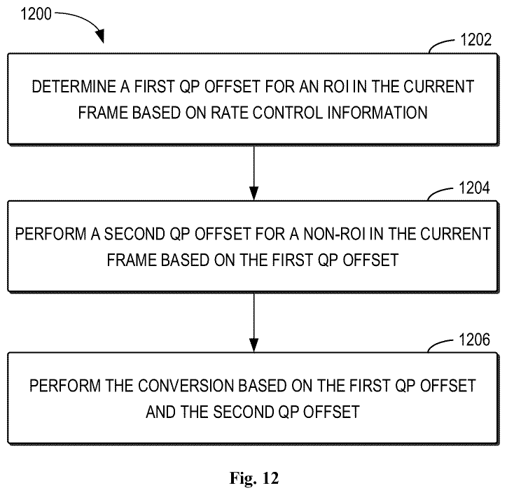

FIG. 12 illustrates a flowchart of a method 1200 for video processing in accordance with some embodiments of the present disclosure. The method 1200 may be implemented during a conversion between a current frame of a video and a bitstream of the video. In some embodiments, the proposed method 1200 may be implemented by a rate control module or the like.

As shown in FIG. 12, the method 1200 starts at 1202 where a first QP offset for a region of interest (ROI) in the current frame is determined based on rate control information. By way of example rather than limitation, the rate control information may comprise QP for encoding one or more frames of the video that are encoded before the current frame. In some embodiments, the first QP offset may be restricted by a maximum QP offset. For example, the first QP offset may not be allowed to larger than the maximum QP offset.

At 1204, a second QP offset for a non-ROI in the current frame is determined based on the first QP offset. This will be described in details blow.

At 1206, the conversion is performed based on the first QP offset and the second QP offset. In some embodiments, a first QP for encoding the ROI may be obtained by adjusting a base QP for encoding the current frame with the first QP offset. A second QP for encoding the non-ROI may be obtained by adjusting the base QP with the second QP offset. Moreover, the conversion may be performed based the first QP and the second QP. For example, the first QP may be smaller than the base QP and the second QP may be larger than the base QP. Additionally, a difference between the first QP offset and the second QP offset may be restricted by a maximum QP difference. For example, the difference between the first QP offset and the second QP offset may not be allowed to be larger than the maximum QP difference.

In some embodiments, the conversion may include encoding the current frame into the bitstream. It should be understood that the above illustrations and/or examples are described merely for purpose of description. The scope of the present disclosure is not limited in this respect.

In view of the above, the QP offsets for ROI and non-ROI are determined based on rate control information. Compared with the conventional solution, the proposed method can advantageously perform the rate control for ROI region and non-ROI region more accurately, and thus the bitrate can be controlled more accurately. Thereby, the coding quality can be improved.

In some embodiments, at 1204, a weighted complexity of the ROI may be determined based on the first QP offset. For example, the weight may be dependent on the first QP offset. By way of example rather than limitation, the weighted complexity of the ROI may be determined as follows:

$$WCR = CR * f ( Δ QP 1 )$$

where WCR represents the weighted complexity of the ROI, CR represents a complexity of the ROI, ΔQP1 represents the first QP offset and f( ) represents a linear function for determining a weight based on a QP offset.

In addition, a weighted complexity of the non-ROI may be determined based on the weighted complexity of the ROI and a complexity of the current frame. By way of example rather than limitation, the weighted complexity of the non-ROI may be determined by subtracting the weighted complexity of the ROI from the complexity of the current frame.

Furthermore, the second QP offset may be determined based on the weighted complexity of the non-ROI. By way of example rather than limitation, the second QP offset may be determined as follows:

$$Δ QP 2 = g ( CNR , WCNR )$$

where ΔQP2 represents the second QP offset, CNR represents a complexity of the non-ROI, WCNR represents the weighted complexity of the non-ROI, and g( ) represents a non-linear function for determining a QP offset based on a complexity.

In view of the above, the solutions in accordance with some embodiments of the present disclosure can advantageously improve coding efficiency and coding quality.

According to further embodiments of the present disclosure, a non-transitory computer-readable recording medium is provided. The non-transitory computer-readable recording medium stores a bitstream of a video which is generated by a method performed by an apparatus for video processing. In the method, a first QP offset for a region of interest (ROI) in a current frame of the video is determined based on rate control information. A second QP offset for a non-ROI in the current frame is determined based on the first QP offset. Moreover, the bitstream is generated based on the first QP offset and the second QP offset.

According to still further embodiments of the present disclosure, a method for storing bitstream of a video is provided. In the method, a first QP offset for a region of interest (ROI) in a current frame of the video is determined based on rate control information. A second QP offset for a non-ROI in the current frame is determined based on the first QP offset. Moreover, the bitstream is generated based on the first QP offset and the second QP offset, and stored in a non-transitory computer-readable recording medium.

Implementations of the present disclosure can be described in view of the following clauses, the features of which can be combined in any reasonable manner.

Clause 1. A method for video processing, comprising: determining, for a conversion between a current frame of a video and a bitstream of the video, rate control information for encoding a current block in the current frame, the rate control information being determined at least based on information of a first set of blocks in the current frame that is encoded before the current block; and performing the conversion based on the rate control information.

Clause 2. The method of clause 1, wherein the rate control information comprises a quantization parameter (QP).

Clause 3. The method of any of clauses 1-2, wherein the current frame is encoded based on a parallel processing scheme in which the current frame is encoded based on at least one processing unit.

Clause 4. The method of clause 3, wherein the parallel processing scheme comprises wavefront parallel processing (WPP), and the at least one processing unit comprises the current frame, or wherein the parallel processing scheme comprises multi-tile parallel processing, and the at least one processing unit comprises a plurality of tiles in the current frame.

Clause 5. The method of any of clauses 1-4, wherein the first set of blocks and the current block are comprised in the same processing unit of the video, and the information of the first set of blocks comprises the actual number of bits for encoding the first set of blocks.

Clause 6. The method of clause 5, wherein the information of the first set of blocks further comprises a weighted complexity of the first set of blocks.

Clause 7. The method of clause 6, wherein the actual number of bits for encoding the first set of blocks and the weighted complexity of the first set of blocks are dependent on an encoding order of blocks.

Clause 8. The method of any of clauses 4-7, wherein if the parallel processing scheme comprises the wavefront parallel processing, the first set of blocks comprises top blocks and left-top blocks of the current block, or if the parallel processing scheme comprises the multi-tile parallel processing, the first set of blocks comprises blocks preceding the current block in each tile.

Clause 9. The method of clause 6, wherein the actual number of bits for encoding the first set of blocks and the weighted complexity of the first set of blocks are dependent on a location of the current block.

Clause 10. The method of any of clauses 5-9, wherein the actual number of bits for encoding the first set of blocks is determined based on a sum of the actual number of bits for encoding each of the first set of blocks.

Clause 11. The method of any of clauses 6-10, wherein the rate control information is determined further based on a weighted complexity of a second set of blocks to be encoded, and the second set of blocks and the first set of blocks are in the same processing unit of the video.

Clause 12. The method of clause 11, wherein the weighted complexity of the second set of blocks is determined based on the weighted complexity of the first set of blocks and a weighted complexity of a current processing unit comprising the current block.

Clause 13. The method of clause 12, wherein the weighted complexity of the second set of blocks is determined based on a result of subtracting the weighted complexity of the first set of blocks from the weighted complexity of the current processing unit.

Clause 14. The method of any of clauses 11-13, wherein the rate control information is determined further based on a target range of the number of bits for encoding the second set of blocks.

Clause 15. The method of clause 14, wherein the target range of the number of bits for encoding the second set of blocks is determined based on the actual number of bits for encoding the first set of blocks and the target number of bits for encoding a current processing unit comprising the current block.

Clause 16. The method of clause 15, wherein the target range of the number of bits for encoding the second set of blocks is determined based on a result of subtracting the actual number of bits for encoding the first set of blocks from the target number of bits for encoding the current processing unit.

Clause 17. The method of any of clauses 14-16, wherein the rate control information is determined further based on a first prediction for the number of bits for coding the second set of blocks.

Clause 18. The method of clause 17, wherein the first prediction is determined based on the actual number of bits for encoding the first set of blocks, the weighted complexity of the first set of blocks, and the weighted complexity of the second set of blocks.

Clause 19. The method of clause 18, wherein the first prediction is determined based on a linear function of the actual number of bits for encoding the first set of blocks, the weighted complexity of the first set of blocks, and the weighted complexity of the second set of blocks.

Clause 20. The method of clause 17, wherein the first prediction is determined as follows:

$$ELB = R * ( {\sum }_{i ∈ Ω} {W}_{i} * {C}_{i} )$$

$$R = ( {\sum }_{i ∈ Ω} {B}_{i} ) / ( {\sum }_{i ∈ Ω} {W}_{i} * {C}_{i} )$$

where ELB represents the first prediction, Wᵢ represents a weight for a block with an index i, Cᵢ represents a complexity of a block with an index i, Bᵢ represents the actual number of bits for coding a block with an index i, and Ω represents the first set of blocks.

Clause 21. The method of clause 20, wherein a plurality of weights for weighting complexity of a plurality of blocks are the same, or wherein at least two of the plurality of weights are different from each other.

Clause 22. The method of any of clauses 20-21, wherein the complexity of a block with an index i is determined based on a distortion metric.

Clause 23. The method of clause 22, wherein the distortion metric comprises one of the following: a sum of absolute differences (SAD), a sum of squared error (SSE), or a mean sum of squared error (MSE).

Clause 24. The method of any of clauses 17-23, wherein the rate control information is determined further based on a second prediction for the number of bits for encoding a current processing unit comprising the current block.

Clause 25. The method of clause 24, wherein the second prediction is determined based on the actual number of bits for encoding the first set of blocks and the first prediction.

Clause 26. The method of clause 25, wherein the second prediction is determined based on a sum of the actual number of bits for encoding the first set of blocks and the first prediction.

Clause 27. The method of any of clauses 24-26, wherein determining the rate control information for encoding the current block comprises: generating the rate control information for encoding the current block based on the second prediction and a rate control information for encoding a first block in the first set of blocks.

Clause 28. The method of clause 27, wherein the rate control information comprises a quantization parameter, and generating the rate control information for encoding the current block comprises: if the second prediction is smaller than a first threshold, determining the quantization parameter for encoding the current block by decreasing the quantization parameter for encoding the first block, or if the second prediction is larger than a second threshold, determining the quantization parameter for encoding the current block by increasing the quantization parameter for encoding the first block, or if the second prediction is within a range from the first threshold to the second threshold, determining the quantization parameter for encoding the current block as the quantization parameter for encoding the first block.

Clause 29. The method of clause 28, wherein the first threshold is the minimum allowed number of bits for encoding the current processing unit, and the second threshold is the maximum allowed number of bits for encoding the current processing unit.

Clause 30. The method of clause 29, wherein the parallel processing scheme comprises multi-tile parallel processing, and the minimum allowed number of bits for encoding the current processing unit and the maximum allowed number of bits for encoding the current processing unit are determined as follows:

$$MAX TB = max fb * ( {\sum }_{j ∈ N} {W}_{j} {C}_{j} ) / ( {\sum }_{j ∈ M} {W}_{j} {C}_{j} )$$

$$MIN TB = min fb * ( {\sum }_{j ∈ N} {W}_{j} {C}_{j} ) / ( {\sum }_{j ∈ M} {W}_{j} {C}_{j} )$$

where MAXTB represents the maximum allowed number of bits for encoding the current processing unit, maxfb represents the maximum allowed number of bits for encoding the current frame, Wⱼ represents a weight for a block with an index j, Cⱼ represents a complexity of a block with an index j, and N represents all blocks of the current processing unit, and M represents all blocks of the current frame.

Clause 31. The method of clause 30, wherein the target number of bits for encoding the current processing unit is determined as follows:

$$TETB = estfb * ( {\sum }_{j ∈ N} {W}_{j} {C}_{j} ) / ( {\sum }_{j ∈ M} {W}_{j} {C}_{j} )$$

where TETB represents the target number of bits for encoding the current processing unit, estfb represents the target number of bits for encoding the current frame, W represents a weight for a block with an index j, Cⱼ represents a complexity of a block with an index j, and N represents all blocks of the current processing unit, and M represents all blocks of the current frame.

Clause 32. A method for video processing, comprising: determining, for a conversion between a current frame of a video and a bitstream of the video, first information regarding when to synchronize encoding information of the video to a rate control for encoding the video, the first information being determined based on rate control information for encoding a set of frames of the video that is encoded before the current frame; and performing the conversion based on the first information.

Clause 33. The method of clause 32, wherein the encoding information is synchronized based on a maximum synchronization interval for synchronizing the encoding information.

Clause 34. The method of any of clauses 32-33, wherein the rate control information comprises the smallest base QP since the latest synchronization point where the encoding information is synchronized, and a base QP is used for encoding a frame of the video.

Clause 35. The method of clause 34, wherein if a base QP for encoding the current frame is smaller than the smallest base QP and a difference between the base QP and the smallest base QP is larger than a threshold, the encoding information is synchronized.

Clause 36. The method of any of clauses 32-35, wherein the rate control information comprises the largest base QP since the latest synchronization point where the encoding information is synchronized, and a base QP is used for encoding a frame of the video.

Clause 37. The method of clause 36, wherein if a base QP for encoding the current frame is larger than the largest base QP and a difference between the base QP and the largest base QP is larger than a threshold, the encoding information is synchronized.

Clause 38. The method of any of clauses 32-37, wherein the rate control information comprises a historical weighted average base QP.

Clause 39. The method of any of clauses 32-38, wherein the encoding information is synchronized if all of the following conditions are met: each of base QPs for encoding a first plurality of frames in the set of frames is smaller than a third threshold, the number of the first plurality of frames is larger than a predetermined number, and a historical average base QP is smaller than a fourth threshold.

Clause 40. The method of any of clauses 32-39, wherein the encoding information is synchronized if all of the following conditions are met: each of base QPs for encoding a second plurality of frames in the set of frames is larger than a fifth threshold, the number of the second plurality of frames is larger than a predetermined number, and a historical average base QP is larger than a sixth threshold.

Clause 41. The method of any of clauses 32-40, wherein the current frame is encoded based on a parallel processing scheme.

Clause 42. A method for video processing, comprising: determining, for a conversion between a current frame of a video and a bitstream of the video, a first QP offset for a region of interest (ROI) in the current frame based on rate control information; determining a second QP offset for a non-ROI in the current frame based on the first QP offset; and performing the conversion based on the first QP offset and the second QP offset.

Clause 43. The method of clause 42, performing the conversion comprising: obtaining a first QP for encoding the ROI by adjusting a base QP for encoding the current frame with the first QP offset; obtaining a second QP for encoding the non-ROI by adjusting the base QP with the second QP offset; and performing the conversion based the first QP and the second QP.

Clause 44. The method of any of clauses 43-44, wherein determining the second QP offset comprises: determining a weighted complexity of the ROI based on the first QP offset; determining a weighted complexity of the non-ROI based on the weighted complexity of the ROI and a complexity of the current frame; and determining the second QP offset based on the weighted complexity of the non-ROI.

Clause 45. The method of clause 44, wherein the weighted complexity of the ROI is determined as follows:

$$WCR = CR * f ( Δ QP 1 )$$

where WCR represents the weighted complexity of the ROI, CR represents a complexity of the ROI, ΔQP1 represents the first QP offset and f( ) represents a linear function for determining a weight based on a QP offset.

Clause 46. The method of any of clauses 44-45, wherein the weighted complexity of the non-ROI is determined by subtracting the weighted complexity of the ROI from the complexity of the current frame.

Clause 47. The method of any of clauses 44-46, wherein the second QP offset is determined as follows:

$$Δ QP 2 = g ( CNR , WCNR )$$

where ΔQP2 represents the second QP offset, CNR represents a complexity of the non-ROI, WCNR represents the weighted complexity of the non-ROI, and g( ) represents a non-linear function for determining a QP offset based on a complexity.

Clause 48. The method of any of clauses 42-47, wherein the first QP offset is restricted by a maximum QP offset.

Clause 49. The method of any of clauses 42-48, wherein a difference between the first QP offset and the second QP offset is restricted by a maximum QP difference.

Clause 50. The method of any of clauses 1-49, wherein the method is implemented by a rate control module.

Clause 51. The method of any of clauses 1-50, wherein the conversion includes encoding the current frame into the bitstream.

Clause 52. An apparatus for video processing comprising a processor and a non-transitory memory with instructions thereon, wherein the instructions upon execution by the processor, cause the processor to perform a method in accordance with any of clauses 1-51.

Clause 53. A non-transitory computer-readable storage medium storing instructions that cause a processor to perform a method in accordance with any of clauses 1-51.

Clause 54. A non-transitory computer-readable recording medium storing a bitstream of a video which is generated by a method performed by an apparatus for video processing, wherein the method comprises: determining rate control information for encoding a current block in a current frame of the video, the rate control information being determined at least based on information of a first set of blocks in the current frame that is encoded before the current block; and generating the bitstream based on the rate control information.

Clause 55. A method for storing a bitstream of a video, comprising: determining rate control information for encoding a current block in a current frame of the video, the rate control information being determined at least based on information of a first set of blocks in the current frame that is encoded before the current block; generating the bitstream based on the rate control information; and storing the bitstream in a non-transitory computer-readable recording medium.

Clause 56. A non-transitory computer-readable recording medium storing a bitstream of a video which is generated by a method performed by an apparatus for video processing, wherein the method comprises: determining first information regarding when to synchronize encoding information of the video to a rate control for encoding the video, the first information being determined based on rate control information for encoding a set of frames of the video that is encoded before a current frame of the video; and generating the bitstream based on the first information.

Clause 57. A method for storing a bitstream of a video, comprising: determining first information regarding when to synchronize encoding information of the video to a rate control for encoding the video, the first information being determined based on rate control information for encoding a set of frames of the video that is encoded before a current frame of the video; generating the bitstream based on the first information; and storing the bitstream in a non-transitory computer-readable recording medium.

Clause 58. A non-transitory computer-readable recording medium storing a bitstream of a video which is generated by a method performed by an apparatus for video processing, wherein the method comprises: determining a first QP offset for a region of interest (ROI) in a current frame of the video based on rate control information; determining a second QP offset for a non-ROI in the current frame based on the first QP offset; and generating the bitstream based on the first QP offset and the second QP offset.

Clause 59. A method for storing a bitstream of a video, comprising: determining a first QP offset for a region of interest (ROI) in a current frame of the video based on rate control information; determining a second QP offset for a non-ROI in the current frame based on the first QP offset; generating the bitstream based on the first QP offset and the second QP offset; and storing the bitstream in a non-transitory computer-readable recording medium.

### Example Device

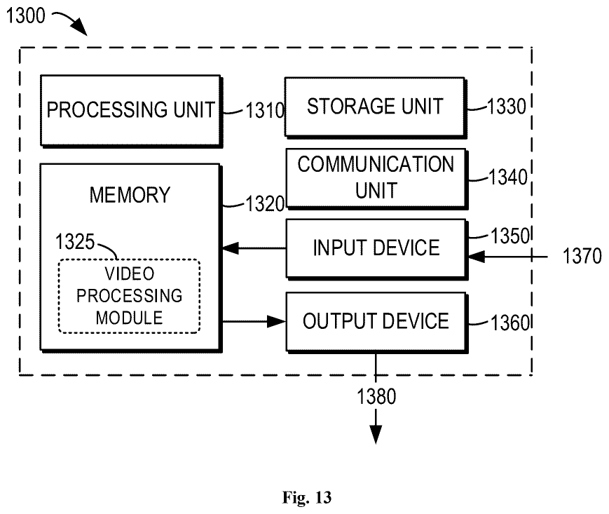

FIG. 13 illustrates a block diagram of a computing device 1300 in which various embodiments of the present disclosure can be implemented. The computing device 1300 may be implemented as or included in the source device 110 (or the video encoder 114 or 200) or the destination device 120 (or the video decoder 124 or 300).

It would be appreciated that the computing device 1300 shown in FIG. 13 is merely for purpose of illustration, without suggesting any limitation to the functions and scopes of the embodiments of the present disclosure in any manner.

As shown in FIG. 13, the computing device 1300 includes a general-purpose computing device 1300. The computing device 1300 may at least comprise one or more processors or processing units 1310, a memory 1320, a storage unit 1330, one or more communication units 1340, one or more input devices 1350, and one or more output devices 1360.

In some embodiments, the computing device 1300 may be implemented as any user terminal or server terminal having the computing capability. The server terminal may be a server, a large-scale computing device or the like that is provided by a service provider. The user terminal may for example be any type of mobile terminal, fixed terminal, or portable terminal, including a mobile phone, station, unit, device, multimedia computer, multimedia tablet, Internet node, communicator, desktop computer, laptop computer, notebook computer, netbook computer, tablet computer, personal communication system (PCS) device, personal navigation device, personal digital assistant (PDA), audio/video player, digital camera/video camera, positioning device, television receiver, radio broadcast receiver, E-book device, gaming device, or any combination thereof, including the accessories and peripherals of these devices, or any combination thereof. It would be contemplated that the computing device 1300 can support any type of interface to a user (such as “wearable” circuitry and the like).

The processing unit 1310 may be a physical or virtual processor and can implement various processes based on programs stored in the memory 1320. In a multi-processor system, multiple processing units execute computer executable instructions in parallel so as to improve the parallel processing capability of the computing device 1300. The processing unit 1310 may also be referred to as a central processing unit (CPU), a microprocessor, a controller or a microcontroller.

The computing device 1300 typically includes various computer storage medium. Such medium can be any medium accessible by the computing device 1300, including, but not limited to, volatile and non-volatile medium, or detachable and non-detachable medium. The memory 1320 can be a volatile memory (for example, a register, cache, Random Access Memory (RAM)), a non-volatile memory (such as a Read-Only Memory (ROM), Electrically Erasable Programmable Read-Only Memory (EEPROM), or a flash memory), or any combination thereof. The storage unit 1330 may be any detachable or non-detachable medium and may include a machine-readable medium such as a memory, flash memory drive, magnetic disk or another other media, which can be used for storing information and/or data and can be accessed in the computing device 1300.

The computing device 1300 may further include additional detachable/non-detachable, volatile/non-volatile memory medium. Although not shown in FIG. 13, it is possible to provide a magnetic disk drive for reading from and/or writing into a detachable and non-volatile magnetic disk and an optical disk drive for reading from and/or writing into a detachable non-volatile optical disk. In such cases, each drive may be connected to a bus (not shown) via one or more data medium interfaces.

The communication unit 1340 communicates with a further computing device via the communication medium. In addition, the functions of the components in the computing device 1300 can be implemented by a single computing cluster or multiple computing machines that can communicate via communication connections. Therefore, the computing device 1300 can operate in a networked environment using a logical connection with one or more other servers, networked personal computers (PCs) or further general network nodes.

The input device 1350 may be one or more of a variety of input devices, such as a mouse, keyboard, tracking ball, voice-input device, and the like. The output device 1360 may be one or more of a variety of output devices, such as a display, loudspeaker, printer, and the like. By means of the communication unit 1340, the computing device 1300 can further communicate with one or more external devices (not shown) such as the storage devices and display device, with one or more devices enabling the user to interact with the computing device 1300, or any devices (such as a network card, a modem and the like) enabling the computing device 1300 to communicate with one or more other computing devices, if required. Such communication can be performed via input/output (I/O) interfaces (not shown).

In some embodiments, instead of being integrated in a single device, some or all components of the computing device 1300 may also be arranged in cloud computing architecture. In the cloud computing architecture, the components may be provided remotely and work together to implement the functionalities described in the present disclosure. In some embodiments, cloud computing provides computing, software, data access and storage service, which will not require end users to be aware of the physical locations or configurations of the systems or hardware providing these services. In various embodiments, the cloud computing provides the services via a wide area network (such as Internet) using suitable protocols. For example, a cloud computing provider provides applications over the wide area network, which can be accessed through a web browser or any other computing components. The software or components of the cloud computing architecture and corresponding data may be stored on a server at a remote position. The computing resources in the cloud computing environment may be merged or distributed at locations in a remote data center. Cloud computing infrastructures may provide the services through a shared data center, though they behave as a single access point for the users. Therefore, the cloud computing architectures may be used to provide the components and functionalities described herein from a service provider at a remote location. Alternatively, they may be provided from a conventional server or installed directly or otherwise on a client device.

The computing device 1300 may be used to implement video encoding/decoding in embodiments of the present disclosure. The memory 1320 may include one or more video coding modules 1325 having one or more program instructions. These modules are accessible and executable by the processing unit 1310 to perform the functionalities of the various embodiments described herein.

In the example embodiments of performing video encoding, the input device 1350 may receive video data as an input 1370 to be encoded. The video data may be processed, for example, by the video coding module 1325, to generate an encoded bitstream. The encoded bitstream may be provided via the output device 1360 as an output 1380.

In the example embodiments of performing video decoding, the input device 1350 may receive an encoded bitstream as the input 1370. The encoded bitstream may be processed, for example, by the video coding module 1325, to generate decoded video data. The decoded video data may be provided via the output device 1360 as the output 1380.

While this disclosure has been particularly shown and described with references to preferred embodiments thereof, it will be understood by those skilled in the art that various changes in form and details may be made therein without departing from the spirit and scope of the present application as defined by the appended claims. Such variations are intended to be covered by the scope of this present application. As such, the foregoing description of embodiments of the present application is not intended to be limiting.

I/We claim:

1. A method for video processing, comprising:
determining, for a conversion between a current frame of a video and a bitstream of the video, rate control information for encoding a current block in the current frame, the rate control information being determined at least based on information of a first set of blocks in the current frame that is encoded before the current block; and
performing the conversion based on the rate control information.

2. The method of claim 1, wherein the rate control information comprises a quantization parameter (QP), or
wherein the current frame is encoded based on a parallel processing scheme in which the current frame is encoded based on at least one processing unit.

3. The method of claim 2, wherein the parallel processing scheme comprises wavefront parallel processing (WPP), and the at least one processing unit comprises the current frame, or
wherein the parallel processing scheme comprises multi-tile parallel processing, and the at least one processing unit comprises a plurality of tiles in the current frame.

4. The method of claim 1, wherein the first set of blocks and the current block are comprised in the same processing unit of the video, and the information of the first set of blocks comprises the actual number of bits for encoding the first set of blocks.

5. The method of claim 4, wherein the information of the first set of blocks further comprises a weighted complexity of the first set of blocks.

6. The method of claim 5, wherein the rate control information is determined further based on a weighted complexity of a second set of blocks to be encoded, and the second set of blocks and the first set of blocks are in the same processing unit of the video.

7. The method of claim 6, wherein the weighted complexity of the second set of blocks is determined based on the weighted complexity of the first set of blocks and a weighted complexity of a current processing unit comprising the current block.

8. The method of claim 7, wherein the weighted complexity of the second set of blocks is determined based on a result of subtracting the weighted complexity of the first set of blocks from the weighted complexity of the current processing unit.

9. The method of claim 6, wherein the rate control information is determined further based on a target range of the number of bits for encoding the second set of blocks.

10. The method of claim 9, wherein the target range of the number of bits for encoding the second set of blocks is determined based on the actual number of bits for encoding the first set of blocks and the target number of bits for encoding a current processing unit comprising the current block, or
wherein the rate control information is determined further based on a first prediction for the number of bits for coding the second set of blocks.

11. The method of claim 10, wherein the first prediction is determined based on the actual number of bits for encoding the first set of blocks, the weighted complexity of the first set of blocks, and the weighted complexity of the second set of blocks, or
wherein the rate control information is determined further based on a second prediction for the number of bits for encoding a current processing unit comprising the current block.

12. The method of claim 1, further comprising:
determining first information regarding when to synchronize encoding information of the video to a rate control for encoding the video, wherein the first information is determined based on further rate control information for encoding a set of frames of the video that is encoded before the current frame, and the conversion is performed based on the first information.

13. The method of claim 12, wherein the encoding information is synchronized based on a maximum synchronization interval for synchronizing the encoding information, or
wherein the further rate control information comprises the smallest base QP since the latest synchronization point where the encoding information is synchronized, and a base QP is used for encoding a frame of the video, or
wherein the further rate control information comprises the largest base QP since the latest synchronization point where the encoding information is synchronized, and a base QP is used for encoding a frame of the video, or
wherein the further rate control information comprises a historical weighted average base QP, or
wherein the encoding information is synchronized if all of the following conditions are met:
each of base QPs for encoding a first plurality of frames in the set of frames is smaller than a third threshold,
the number of the first plurality of frames is larger than a predetermined number, and
a historical average base QP is smaller than a fourth threshold, or
wherein the encoding information is synchronized if all of the following conditions are met:
each of base QPs for encoding a second plurality of frames in the set of frames is larger than a fifth threshold,
the number of the second plurality of frames is larger than a predetermined number, and
a historical average base QP is larger than a sixth threshold, or
wherein the current frame is encoded based on a parallel processing scheme.

14. The method of claim 1, further comprising:
determining a first QP offset for a region of interest (ROI) in the current frame based on the rate control information; and
determining a second QP offset for a non-ROI in the current frame based on the first QP offset,
wherein the conversion is performed based on the first QP offset and the second QP offset.

15. The method of claim 14, performing the conversion comprising:
obtaining a first QP for encoding the ROI by adjusting a base QP for encoding the current frame with the first QP offset;
obtaining a second QP for encoding the non-ROI by adjusting the base QP with the second QP offset; and
performing the conversion based the first QP and the second QP.

16. The method of claim 15, wherein determining the second QP offset comprises:
determining a weighted complexity of the ROI based on the first QP offset;
determining a weighted complexity of the non-ROI based on the weighted complexity of the ROI and a complexity of the current frame; and
determining the second QP offset based on the weighted complexity of the non-ROI.

17. The method of claim 1, wherein the conversion includes encoding the current frame into the bitstream.

18. An apparatus for video processing comprising a processor and a non-transitory memory with instructions thereon, wherein the instructions upon execution by the processor, cause the processor to perform acts comprising:
determining, for a conversion between a current frame of a video and a bitstream of the video, rate control information for encoding a current block in the current frame, the rate control information being determined at least based on information of a first set of blocks in the current frame that is encoded before the current block; and
performing the conversion based on the rate control information.

19. A non-transitory computer-readable storage medium storing instructions that cause a processor to perform acts comprising:
determining, for a conversion between a current frame of a video and a bitstream of the video, rate control information for encoding a current block in the current frame, the rate control information being determined at least based on information of a first set of blocks in the current frame that is encoded before the current block; and
performing the conversion based on the rate control information.

20. A non-transitory computer-readable recording medium storing a bitstream of a video which is generated by a method performed by an apparatus for video processing, wherein the method comprises:
determining rate control information for encoding a current block in a current frame of the video, the rate control information being determined at least based on information of a first set of blocks in the current frame that is encoded before the current block; and
generating the bitstream based on the rate control information.
